(19) United States
(12) Patent Application Publication
(10) Pub. No.: US 2025/0224380 A1
(43) Pub. Date: Jul. 10, 2025

(54) ULTRASONIC INSPECTION ROBOT FOR THREADED CONNECTION STRUCTURE OF ROTOR INTERNAL CAVITY

(71) Applicant: DALIAN UNIVERSITY OF TECHNOLOGY, Dalian (CN)

(72) Inventors: Wei SUN, Dalian (CN); Yingquan WANG, Dalian (CN); Qingchao SUN, Dalian (CN); Zeming XIA, Dalian (CN); Bo YUAN, Dalian (TW); Xiaokai MU, Dalian (TW)

(21) Appl. No.: 19/089,990

(22) Filed: Mar. 25, 2025

Related U.S. Application Data
(63) Continuation of application No. PCT/CN2024/124098, filed on Oct. 11, 2024.

(51) Int. Cl. G01N 29/22

(52) U.S. Cl. CPC G01N 29/225; G01N 2291/2691; G01N 2291/2693

(57) ABSTRACT

An ultrasonic inspection robot for a threaded connection structure of a rotor internal cavity includes a main rack, a clamping module, a lifting module, a rotating module, a telescopic module and a probe buffer module. The present invention can be operated in a narrow, long and strongly restricted space, realizes the inspection of the nut that is inaccessible to the naked eye by carrying testing probes realizes the automated measurement function of placement and pressing of the carried probes, the switching between different test points, and all the points to be measured in an axial direction, and the deformation action of the device, realizes the extension and reduction of the axial and radial dimensions of the device, and completes all functions of placing and taking out the whole device. Moreover, the above functions can be realized only through one device.

### TECHNICAL FIELD

The present invention belongs to the technical field of inspection robots, and relates to an ultrasonic inspection robot for a threaded connection structure of a rotor internal cavity.

### BACKGROUND

The assembly operation of an aero-engine rotor interface is carried out in a narrow space. Branch connection of the assembly surface will directly influence the service performance of the whole aero-engine rotor.

The main connection form of the aero-engine rotor is the structural connection form of seam allowance interference assembly+bolt and nut connection+end surface fitting. This assembly mode brings high quality and high performance of ideal assembly, and also brings the difficulty of control and accurate estimation of assembly quality in an actual assembly process. The consistency of the applied tightening mass preload of a nut affects not only the service performance of the whole rotor, but also the service life of a bolt group. Meanwhile, due to the existence of seam allowance interference connection, the actual fitting condition of the connection structure is unpredictable, and is difficult to achieve the purpose of controlling the actual ideal fitting condition of the joint surface by the traditional bolt torque control method.

In addition, the position of connecting the nut by a high-pressure rotor is generally in a long, narrow and strongly restricted rotor internal cavity. The typical feature of this structure is that an inlet at the rear end of the rotor is very small. However, the diameter of an indexing circle of the nut and the diameter of an indexing circle of a part to be inspected are more than several times the diameter of the inlet. The positions of a bolt head and the nut may be blocked by a rotor disc, and the positions of the bolt head and the nut are invisible to the human eyes, causing extreme inconvenience of the installation of a testing probe at a test position and the impossibility of ensuring the repeatability of position measurement by manual placement.

In the assembly process of a high-pressure turbine rotor, the traditional purely mechanical mode is used for tightening the nut in the current assembly layout solutions. In the tightening mode, due to the vertical assembly form of the high-voltage rotor, the invisibility to the human eyes for the nut installation and tightening position makes the problem of poor consistency of nut tightening caused by seam allowance interference connection more serious, and also brings many problems such as large dispersion of tightening result scores, poor and unpredictable fitting degree of the assembly interface, etc. For example, the ultrasonic testing method of the threaded connection structure needs to place two testing probes respectively on the upper and lower surfaces of the interface to be tested to ensure that a certain pressing force is applied while the probes are perpendicular to the surfaces of the interface. In addition, it is also necessary to ensure the coaxiality of the center lines of the two probes. Many factors indicate that good or bad probe placement will have a great influence on the accuracy of testing results. In addition, due to the constraints of the strongly restricted space in the rotor, because of vertical assembly of the rotor at the part to be tested, the inlet at the rear end is far away from the testing position, and the testing part is invisible to naked eyes due to the existence of the rotor disc. The interface measurement mode of manually placing the probes brings many problems such as high personnel operation strength, testing result instability, low testing reliability and repeatability, etc.

Specifically, the current problems to be solved are as follows: the installation positions of the bolt and the nut are in the long, narrow and strongly restricted space of the rotor internal cavity, and the fitting degree position of the assembly interface brought by poor nut tightening dispersion needs to be measured; the diameter of the indexing circle of the position to be measured is more than more than several times the diameter of the diameter of the inlet, and the installation and placement of the measuring probes cannot be directly operated by manual operation; the position to be measured is blocked by the rotor disc, and is invisible to human naked eyes; and it is necessary to ensure the repeatability of the positioning measurement of placement and pressing of the measuring probes at each measuring point.

There are dozens of measurement points in a circle of the installation and assembly position of the high-pressure rotor, and it is necessary to ensure the repeatability of the positioning measurement of placement and pressing of the measuring probes at each measuring point, which is difficult and extremely tedious to operate.

It is necessary to ensure that the testing probes are placed from the rear end of the rotor. The testing probes are placed to the accurate positions to be measured. The whole process of placing, pressing, repeatedly lifting and dropping, recovering and moving the testing probes needs to be completed in an invisible blind spot. It is necessary to ensure that the probes are switched between different measuring points in a circle of indexing circle, ensure consistency of the repeated positioning of each measuring point and improve the accuracy and the reliability of measurement.

For the high-pressure turbine rotor, seam allowance interference-interface contact condition of bolt connection and joint part are used for inspection. It is desired to propose a technical solution to effectively solve the placement, pressing, repeated lifting and dropping, recovery, movement and withdrawal of the probes, so as to at least solve one of the above problems.

### SUMMARY

The purpose of the present invention is to provide an ultrasonic inspection robot for a threaded connection structure of a rotor internal cavity. The robot can realize automated inspection operation for the evaluation parameter test acquisition process of the threaded connection structure in a strongly restricted space similar to the rotor internal cavity.

The technical solution of the present invention is as follows:

An ultrasonic inspection robot for a threaded connection structure of a rotor internal cavity comprises a main rack, a clamping module, a lifting module, a rotating module, a telescopic module and a probe buffer module; wherein:

The main rack is used for mutual connection among the modules. The main rack comprises an upper connecting disc, a lower connecting disc, an upper sliding spline shaft, a lower sliding spline shaft, an upper rotating shaft seat, a lower rotating shaft seat, an upper ball spline sleeve and a lower ball spline sleeve. The upper rotating shaft seat and the lower rotating shaft seat are connected with the upper connecting disc and the lower connecting disc respectively as a basis for the connection of other modules and supporting of the rack. The upper ball spline sleeve and the lower ball spline sleeve can freely move back and forth linearly along grooves on the upper sliding spline shaft and the lower sliding spline shaft, and meanwhile, a less torque can be transferred to the spline sleeves through the function of maintaining axial motion for the sliding spline shafts. The upper ball spline sleeve and the lower ball spline sleeve are connected with a first upper rotating ball bearing inner ring fixing disc, a second upper rotating ball bearing inner ring fixing disc, a second lower rotating ball bearing inner ring fixing disc and a first lower rotating ball bearing inner ring fixing disc in the rotating module to drive the upper and lower parts of the whole mechanism to move back and forth along the sliding spline shafts to complete switching between the end points of two motion phases in a folded free state and an installation state. In the functional performance of realizing the own deformation of the device, the lower ball spline sleeve is fixed relative to the lower connecting disc and the lower sliding spline shaft, and has no relative displacement. When an upper mechanism is driven away from a lower mechanism by the upper ball spline sleeve and moves to a farthest end, the radial dimension of the device is reduced and the axial dimension is increased correspondingly under the joint action of other modules. Stable connection of each module and reliable operation of the whole device are achieved.

The main rack is divided into two parts, i.e., an upper rack and a lower rack, and comprises a bracket disc and structural parts such as a common rotating shaft; and the upper rack element and the lower rack element can be connected with other modules to move back and forth axially along the common rotating shaft, and have the end points of two motion phases in the free state and the installation state. In the free state, the upper rack element and the lower rack element move to the farthest end of the relative position and drive other modules together to maintain the free state of the whole device so that the radial storage volume of the whole device is minimum. In the installation state, the upper rack element and the lower rack element move to the nearest end of the relative position and drive other modules together to maintain the installation state of the whole device so that the whole device has a relative fixed position relationship with a rotor disc.

The clamping module is used for installation, clamping and fixation with an element to be tested. At the same time, mechanism motion and deformation occur under the action of own power output, and the corresponding deformation and clamping functions are realized. The clamping module comprises a power-on push rod adjusting plate, a power-on push rod, a power-on push rod adjusting base, a power-on push rod connecting base, a power-on push rod buffer spring fixing housing, an upper rotating shaft, an upper rotating shaft small bearing, an upper rotating shaft seat, an upper supporting rotating arm, a circumferential jaw, a jaw upper rotating shaft, a jaw upper rotating shaft small bearing, a jaw lower rotating shaft, a jaw lower rotating shaft small bearing, a second lower supporting rotating arm, a lower rotating shaft small bearing, a first lower rotating shaft, a second lower rotating shaft, a lower rotating shaft seat, a power-on push rod installing ring, an upper sliding spline shaft, a power-on push rod buffer spring, a power-on push rod buffer spring disc and a first lower supporting rotating arm.

A motion mechanism bracket is composed of the upper rotating shaft, the upper rotating shaft small bearing, the upper rotating shaft seat, the upper supporting rotating arm, the circumferential jaw, the jaw upper rotating shaft, the jaw upper rotating shaft small bearing, the jaw lower rotating shaft, the jaw lower rotating shaft small bearing, the second lower supporting rotating arm, the lower rotating shaft small bearing, the first lower rotating shaft, the second lower rotating shaft, the lower rotating shaft seat and the second lower supporting rotating arm. One of three jaws with circumferential distribution is formed, and the complete motion mechanism bracket of the clamping module is obtained after circumferential array. A power output end is composed of the power-on push rod adjusting plate, the power-on push rod, the power-on push rod adjusting base, the power-on push rod connecting base, the power-on push rod buffer spring fixing housing, the power-on push rod installing ring, the upper sliding spline shaft, the power-on push rod buffer spring and the power-on push rod buffer spring disc. When the module is operated, a power source required by the deformation and clamping actions of the device is provided by the power-on push rod in the power output end. The motion of the power-on push rod provides displacement output, which directly acts on the power-on push rod connecting base, is transferred to the power-on push rod buffer spring through the power-on push rod buffer spring disc and then to the main rack part through the lifting module, and finally acts on the motion mechanism bracket in the clamping module. The direction of the displacement, i.e., the clamping force is changed by 90 degrees through a typical motion mechanism in the motion mechanism, and the clamping force and the displacement are changed from axial action to radial action. Wherein the power-on push rod buffer spring is also used as a safety device when the device generates lifting and other actions, and can realize the maintenance of the clamping force when the displacement output is generated by other module actions. The upper rotating shaft seat and the lower rotating shaft seat in the motion mechanism bracket are connected to the main rack so as to limit the two seats in the same linear direction when generating relative motion. A whole group of motion mechanism brackets distributed in a circumferential array can be simplified as a planar motion mechanism. A planar quadrilateral mechanism is composed of the circumferential jaw, the second lower supporting rotating arm, the lower rotating shaft seat and the second lower supporting rotating arm to ensure that the jaw may not rotate due to actions when the part of the module acts, and maintain a vertical state, so as to provide a basis for the contact and the clamping of the whole device and a tested element. At the power output end, output power is transferred to the motion mechanism bracket by other modules, and the mechanism deforms and moves to finally realize installation, clamping and fixation between an automated testing device and the element to be tested.

Preferably, the clamping force in the clamping module can be applied by the power-on push rod, and can also be provided by an electromagnet and a tension spring. The part comprises an electromagnet tension spring installing base, an electromagnet, a magnetic attraction auxiliary base, a rack tension spring installing base, a tension spring installing rod, a tension spring installing rod fixing nut and a tension spring. During operation, the electromagnet and the magnetic attraction auxiliary base are mutually attached; a middle second electric push rod connecting side plate and a middle second electric push rod are used for transferring a spring tension force generated by the tension spring to the lower connecting disc; meanwhile, the tension spring is connected with the rack tension spring installing base; the tension force is transferred to the upper connecting disc, which is represented as an acting force between the upper connecting disc and the lower connecting disc; and the function is equivalent to an operating state when a thrust exerted by the power-on push rod acts on the main rack, and finally acts on the motion mechanism bracket in the clamping module.

The clamping modules are arranged around the main rack module and distributed in a circumferential array, and each comprises the motion mechanism bracket and the power output end supported by the bracket. The power output end is an electric push rod for providing displacement output for a purpose of applying motion displacement for the relative motion and the opposite motion of the upper and lower parts of the main rack. In the free state, the clamping module bracket is withdrawn to minimize the storage dimension of the whole device. In the installation state, the relative position relationship between the whole structure of the testing device and a tested part of the rotor structure is fixed to achieve a centering effect. A variable bracket structure comprising bearings inside the clamping module realizes the function of relative deformation with the relative motion and the opposite motion of the upper and lower parts of the main rack.

Both ends of the lifting module are placed axially and symmetrically in the present invention. The testing device is used for driving each module carried above a lifting platform to conduct reciprocating lifting/dropping actions. The final performance is the lifting and dropping action required by probes at both sides when switching between different measuring points. The lifting module comprises a first upper rotating ball bearing outer ring fixing disc, a second upper rotating ball bearing outer ring fixing disc, an upper connecting disc, a lower connecting disc, a second lower rotating ball bearing outer ring fixing disc, a first lower rotating ball bearing outer ring fixing disc, a lower sliding spline shaft, an upper sliding spline shaft, a magnetic absorption auxiliary base, a middle second electric push rod connecting side plate, a middle second electric push rod, a middle second electric push rod connecting base, a lower linkage optical axis, an upper rotating ball bearing, an upper linkage optical axis base, an upper linkage linear bearing base, an upper linkage linear bearing, an upper linkage optical axis, a lower linkage linear bearing base, a lower linkage linear bearing, a lower linkage optical axis base, a lower rotating ball bearing, a first upper rotating ball bearing inner ring fixing disc, a second upper rotating ball bearing inner ring fixing disc, an upper ball spline sleeve, a lower ball spline sleeve, a second lower rotating ball bearing inner ring fixing disc, a first lower rotating ball bearing inner ring fixing disc, a middle first electric push rod connecting base, a middle first electric push rod, and a middle first electric push rod connecting side plate.

The power output end of the lifting module is composed of the upper connecting disc, the lower connecting disc, the magnetic absorption auxiliary base, the middle second electric push rod connecting side plate, the middle second electric push rod, the middle second electric push rod connecting base, the middle first electric push rod connecting base, the middle first electric push rod and the middle first electric push rod connecting side plate to provide the power required for the lifting/dropping action.

The motion mechanism bracket is composed of a first upper rotating ball bearing outer ring fixing disc, a second upper rotating ball bearing outer ring fixing disc, a second lower rotating ball bearing outer ring fixing disc, a first lower rotating ball bearing outer ring fixing disc, a lower sliding spline shaft, an upper sliding spline shaft, a lower linkage optical axis, an upper rotating ball bearing, an upper linkage optical axis base, an upper linkage linear bearing base, an upper linkage linear bearing, an upper linkage optical axis, a lower linkage linear bearing base, a lower linkage linear bearing, a lower linkage optical axis base, a lower rotating ball bearing, a first upper rotating ball bearing inner ring fixing disc, a second upper rotating ball bearing inner ring fixing disc, an upper ball spline sleeve, a lower ball spline sleeve, a second lower rotating ball bearing inner ring fixing disc, and a first lower rotating ball bearing inner ring fixing disc.

The first upper rotating ball bearing inner ring fixing disc and the first lower rotating ball bearing inner ring fixing disc are the lifting platforms connected directly to other parts in the lifting module. The upper linkage optical axis base and the lower linkage optical axis base are used for fixing the upper linkage optical axis and the lower linkage optical axis respectively. The upper linkage linear bearing base and the lower linkage linear bearing base are used for fixing the upper linkage linear bearing and the lower linkage linear bearing respectively. The linear bearing and the linkage optical axis are matched to realize smooth axial motion between the linkage linear bearing base and the linkage optical axis base, and are called a group of lifting bearing mechanisms. Three groups of lifting bearing mechanisms distributed by the circumferential array ensure that the lifting module can move along the axial direction during actions, to avoid the deviation of the lifting platform in the axial section direction. When the lift/dropping action occurs, the displacement output is provided by the middle first electric push rod and the middle second electric push rod, transferred to the rotating module by the middle first electric push rod connecting base and the middle second electric push rod connecting base, and finally transferred to the lifting platforms in the lifting module to drive other modules on the platforms to move together. The three groups of lifting bearing mechanisms distributed by the circumferential array ensure that the overall motion direction of the lifting module does not deviate when subjected to the acting force of the electric push rod to realize the motion along the axis direction. The lifting module has the function of driving other modules by the lifting platforms to conduct the lifting/dropping actions, which is represented in the whole testing device as the lifting and dropping actions required when the probes at both sides are switched between different measuring points.

The lifting module is divided into two parts placed axially and symmetrically at both ends of the main rack, and comprises the motion mechanism bracket and the power output end supported by the bracket. The power output end comprises the first and the second electric push rods for providing displacement output. The function of the lifting module is to realize the lifting/dropping state switching of the platforms at both ends of the whole device when the main rack and the clamping module are locked in the operating state, that is, in the installation state, that is, the performance is the extension and shortening of the axial length of the whole device. The lifting/dropping actions of the platforms at both ends will drive other modules on the platforms, i.e., the rotating module, the probe buffer module, and the telescopic module, to move together, so as to finally realize the transfer of displacement to such other modules to achieve the corresponding functions.

Part of the rotating module is placed symmetrically at both axial ends of the present invention to realize the circumferential rotation function of the rotating platform relative to the stator part, and part of the components participate in the function when other modules such as the lifting module are operated. The rotating module has the function of realizing circumferential rotation by the whole testing device to drive other modules connected to the rotating platform to rotate together. In the operation of the whole testing device, the performance is the control function of the rotation action and the accurate rotation angle required by a testing probe when an element to be measured is switched between different measuring points. The rotating module comprises a first upper rotating ball bearing outer ring fixing disc, a second upper rotating ball bearing outer ring fixing disc, a second lower rotating ball bearing outer ring fixing disc, a first lower rotating ball bearing outer ring fixing disc, a lower sliding spline shaft, an upper sliding spline shaft, an upper rotating ball bearing, an upper coupling, a middle steering engine first installing edge, a middle first and second steering engine connecting plate, a first middle steering engine, a second middle steering engine, a middle steering engine second installing edge, a middle steering engine first and second installing and connecting base, a lower coupling, a lower rotating ball bearing, a first upper rotating ball bearing inner ring fixing disc, a second upper rotating ball bearing inner ring fixing disc, an upper ball spline sleeve, a lower ball spline sleeve, a second lower rotating ball bearing inner ring fixing disc, and a first lower rotating ball bearing inner ring fixing disc.

A power output end in the rotating module is composed of the middle steering engine first installing edge, the middle first and second steering engine connecting plate, the first middle steering engine, the second middle steering engine, the middle steering engine second installing edge, and the middle steering engine first and second installing and connecting base.

The motion mechanism bracket is composed of the first upper rotating ball bearing outer ring fixing disc, the second upper rotating ball bearing outer ring fixing disc, the second lower rotating ball bearing outer ring fixing disc, the first lower rotating ball bearing outer ring fixing disc, the lower sliding spline shaft, the upper sliding spline shaft, the upper rotating ball bearing, the upper coupling, the lower coupling, the lower rotating ball bearing, the first upper rotating ball bearing inner ring fixing disc, the second upper rotating ball bearing inner ring fixing disc, the upper ball spline sleeve, the lower ball spline sleeve, the second lower rotating ball bearing inner ring fixing disc, and the first lower rotating ball bearing inner ring fixing disc.

The first middle steering engine and the second middle steering engine control the rotation of the upper rotating part and the lower rotating part respectively. Accurate angle control and rotating torque are provided through the steering engines, transferred from the upper coupling and the lower coupling to the lower sliding spline shaft and the upper sliding spline shaft, and finally transferred to a rotor part connected therewith through the upper ball spline sleeve and the lower ball spline sleeve by means of the coordination and torque transfer between the sliding spline shaft and the ball spline sleeve to realize the function of rotation and angle control.

The first upper rotating ball bearing outer ring fixing disc, the second upper rotating ball bearing outer ring fixing disc, the second lower rotating ball bearing outer ring fixing disc and the first lower rotating ball bearing outer ring fixing disc in the motion mechanism bracket are connected with the fixed part of the whole device, which is the stator part of the rotating module. The rotor part in the rotating module is composed of the lower sliding spline shaft, the upper sliding spline shaft, the upper rotating ball bearing, the upper coupling, the lower coupling, the lower rotating ball bearing, the first upper rotating ball bearing inner ring fixing disc, the second upper rotating ball bearing inner ring fixing disc, the upper ball spline sleeve, the lower ball spline sleeve, the second lower rotating ball bearing inner ring fixing disc and the first lower rotating ball bearing inner ring fixing disc. The stator part and the rotor part connected with the upper rotating ball bearing and the lower rotating ball bearing in the rotating module ensure that the rotor part can rotate stably relative to the stator part, i.e., other parts of the whole device when the rotating module is operated and rotated, and ensure the coaxiality and the stability of rotation. The final performance in the rotor part is: the first upper rotating ball bearing inner ring fixing disc and the first lower rotating ball bearing inner ring fixing disc are used as rotating platforms directly connected with other modules, and can rotate smoothly relative to the whole device, so as to finally drive a probe extension arm and a testing probe connected to the rotating platforms to realize stable arrival and switching between different measuring points of the element to be measured.

The rotating module is divided into a motion mechanism bracket and a power output end supported by the bracket. The power output end comprises the first steering engine and the second steering engine for providing the axial rotation torque of the rotating mechanism. The rotating module has the function of ensuring the stable rotation of the rotating rotor part relative to the stator part, to ensure the coaxiality and the stability of rotation. That is, in the installation state, the circumferential rotation action of the rotating platforms at both ends of the device is realized relative to the whole device, which will drive other modules on the rotating platforms, i.e., the probe buffer module and the telescopic module, to move together, and finally realize the circumferential indexing rotation function, which is represented as realizing the measurement phase switching function of the probe at the circumferential point to be measured.

In addition to providing a circumferential stable rotation function, the rotating module also comprises a motion-rotation function connected with a central motion spindle. That is, the circumferential torque of the steering engine is rotated through the power output end and is transferred to the rotating module through a central spindle to provide rotation indexing action displacement. The rotating module can also move axially on the central spindle to drive the main rack and the lifting module connected therewith, so as to achieve the axial dimensional deformation function of the whole device and finally realize and manifest a displacement input source of the clamping module.

The telescopic modules are placed symmetrically at both axial ends of the present invention, used to achieve the rotation of rod components, and manifested as radial dimensional expansion and contraction. In the whole testing device, the performance is to drive a probe part at the end of the rod of the telescopic module to move in the radial direction. The telescopic module comprises an upper probe arm rotating steering engine installing bottom edge, an upper probe arm rotating steering engine installing side edge, an upper probe arm rotating steering engine rack installing base, an upper probe arm rotating steering engine, an upper probe arm rotating steering engine wheel, an upper probe vertical extension arm, an upper probe horizontal extension arm, an upper probe adjusting base, an upper probe bearing clamping and adjusting rod, a lower probe horizontal extension arm, a lower probe adjusting base, a lower probe bearing clamping and adjusting rod, a lower probe vertical extension arm, a lower probe arm rotating steering engine rack installing base, a lower probe arm rotating steering engine wheel, a lower probe arm rotating steering engine, a lower probe arm rotating steering engine installing bottom edge and a lower probe arm rotating steering engine installing side edge.

The power output end in the telescopic module is composed of the upper probe arm rotating steering engine wheel, the upper probe vertical extension arm, the upper probe horizontal extension arm, the upper probe adjusting base, the upper probe bearing clamping and adjusting rod, the lower probe horizontal extension arm, the lower probe adjusting base, the lower probe bearing clamping and adjusting rod, the lower probe vertical extension arm and the lower probe arm rotating steering engine wheel.

The motion mechanism bracket is composed of the upper probe arm rotating steering engine installing bottom edge, the upper probe arm rotating steering engine installing side edge, the upper probe arm rotating steering engine rack installing base, the upper probe arm rotating steering engine, the lower probe arm rotating steering engine rack installing base, the lower probe arm rotating steering engine, the lower probe arm rotating steering engine installing bottom edge and the lower probe arm rotating steering engine installing side edge.

When the rotating module is operated, the upper probe arm rotating steering engine and the lower probe arm rotating steering engine control the rotation function of the axial telescopic module structural bracket part of the upper and lower parts respectively, and the torque and angle control functions required by rotation are provided by the steering engine. The steering engine and the rotating platform in the rotating module are connected through the upper probe arm rotating steering engine installing bottom edge, the upper probe arm rotating steering engine installing side edge, the upper probe arm rotating steering engine rack installing base, the lower probe arm rotating steering engine rack installing base, the lower probe arm rotating steering engine installing bottom edge and the lower probe arm rotating steering engine installing side edge. The first upper rotating ball bearing inner ring fixing disc and the first lower rotating ball bearing inner ring fixing disc are connected and fixed. The steering engine output rotating torque is transferred to the upper probe vertical extension arm and the lower probe vertical extension arm in the axial direction, the upper probe horizontal extension arm and the lower probe horizontal extension arm through the upper probe arm rotating steering engine wheel and the lower probe arm rotating steering engine wheel, to finally realize the rotation function of a semicircular horizontal extension arm. When the horizontal extension arm rotates to a position with the smallest radial dimension in a semicircle, the semicircular horizontal extension arm is located in an outermost ring of the whole testing device. In the operating state, the semicircular horizontal extension arm rotates and extends, and the radial chord length of the semicircle is an actual extension length to realize the elongation of the radial dimension. The upper probe adjusting base, the upper probe bearing clamping and adjusting rod, the lower probe adjusting base and the lower probe bearing clamping and adjusting rod are matched with each other to realize the fine adjustment of the radial dimension elongation, which is convenient for finding the position of the indexing circle of the point to be measured on the measured element when the device is operated. Finally, the probe part installed at the end of the telescopic module is driven in the whole testing device to switch the free state and the operating state to drive the probe part to reach the position of the point to be measured, so as to realize the telescopic function of the radial dimension of the whole device.

The telescopic module comprises a bracket and a power output end supported by the bracket. The power output end comprises an upper and a lower steering engine arm rotating steering engines for providing the axial rotation torque of the rotating mechanism. That is, the telescopic module comprises a multistage arm composed of a bracket, a connecting support and a connecting probe buffer module. The telescopic module also comprises a power output end for providing the radial length expansion and contraction of the whole device to realize the deformation action of the probe extension arm. The overall function of the telescopic module is to realize the expansion and retraction actions of the probe extension arm, that is, to enter a free state after the retraction action occurs and to withdraw the probe arm to satisfy the minimum radial dimensional requirement of the whole device.

The probe buffer module is arranged at the end part of the probe arm bracket part in the telescopic module, and carries a testing probe to realize the accurate positioning function of the testing probe, so as to ensure that a stable pressing force between the probe and the measured element is maintained during the operation of the automated testing device, thereby finally realizing the stability of a measuring structure and realizing the reliability and the stability of the measuring data. The probe buffer module comprises an upper probe bearing clamping and adjusting rod, an upper probe movable linear bearing, an upper probe clamping rod, an upper probe, a lower probe, a lower probe clamping rod, a lower probe movable linear bearing, a lower probe bearing clamping and adjusting rod, an upper probe buffer spring and a lower probe buffer spring.

In the probe buffer module, the upper probe and the lower probe are measuring probes, and are fixed by a probe holding rod. The end of the holding rod is an optical axis, which can move in the upper probe movable linear bearing and the lower probe movable linear bearing along the bearing axis, thereby limiting the movable range of the probe to be perpendicular to the cross section direction of the whole device, that is, perpendicular to the direction of a measured surface of the measured element. The axial displacement applied by the lifting module is finally transferred to the probe buffer module by the rotating module and the telescopic module. The lifting displacement applied is converted into the spring compression by the upper probe buffer spring and the lower probe buffer spring, and converted into a pressing force for keeping the stable attachment of the probe and the measured surface by the buffer spring. The final performance is to ensure that the stable pressing force between the probe and the measured element is maintained during the operation of the automated testing device to ensure the stability and the reliability of the obtained test data.

The probe buffer module is arranged at the end of the probe arm bracket part in the telescopic module, and is composed of a probe, a buffer component and a fine adjustment component to realize the accurate positioning of the probe, maintain the stable pressing force of the probe and ensure the accuracy of the measuring structure and the stability of the measuring data. The probe is fixedly connected with a movable element bracket, and can move linearly relative to the fixed part of the bracket through spring buffer. When the lifting module moves in the operating state, the probe buffer module is operated to complete the transformation of the displacement input to the output of the pressing force, so as to realize the stable pressing and attaching actions of the probe.

Preferably, in addition to the above modules, the present invention also comprises an automated control operating system which comprises a power supply, a single chip microcomputer core board, a control board, a switch, an indicator light and a bracket. All elements of the automated control operating system are installed by the bracket, to play the function of fixation and protection. The automated control operating system and the robot are controlled by wired connection.

The automated control operating system has the function of: controlling various power output components in the system to move or link respectively to finally realize the function of controlling the switching of the whole robot between the free state and the installation operating state.

The present invention can be operated in a narrow, long and strongly restricted space, realizes the inspection of a site inaccessible to naked eyes in a nut by carrying the testing probe, realizes the automated measurement function of placement and pressing of the carried probe, the switching between different test points, and all the points to be measured in the axial direction, and the deformation action of the device, realizes the extension and reduction of the axial and radial dimensions of the device, and completes all functions of placing and taking out the whole device. Moreover, the above functions can be realized only through one device, and the device cost is relatively reduced.

Wherein each module can move along the axial motion of a groove moving mechanism along with the whole rack. A set opening mechanism composed of each module can make the whole device complete the change of the axial dimension and the radial dimension according to a set trajectory, so as to achieve the overall dimensional reduction, and effectively avoid the own structural bump or damage to the engine parts by the device when the strongly restricted rotor internal cavity is opened. The present invention can realize the test work in the strongly restricted space.

### DESCRIPTION OF DRAWINGS

FIG. 1 is a three-dimensional structural schematic diagram 1 of the present invention;

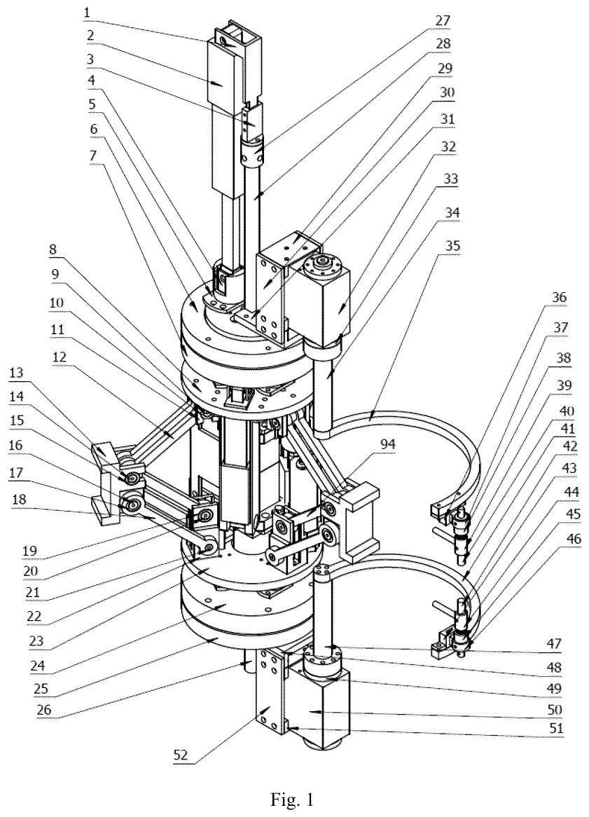

FIG. 2 is a side view of FIG. 1;

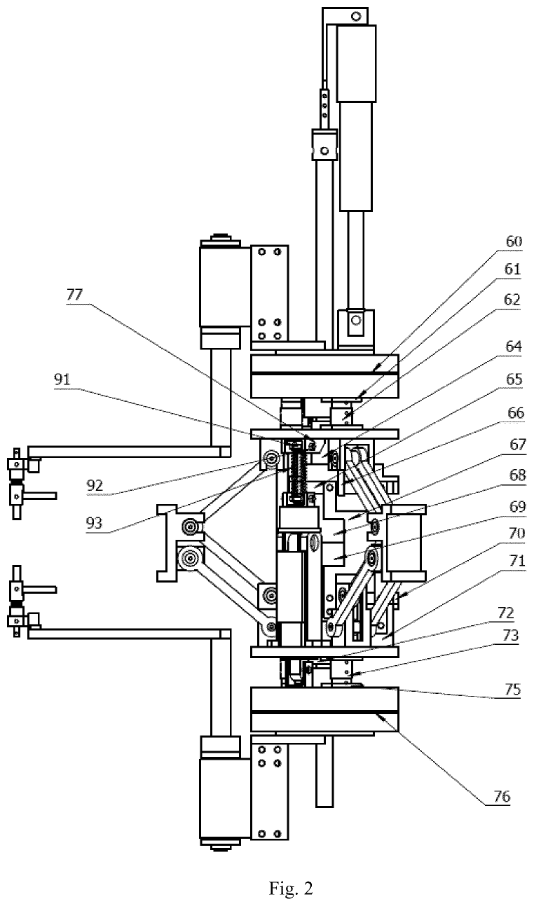

FIG. 3 is a three-dimensional structural schematic diagram 2 of the present invention;

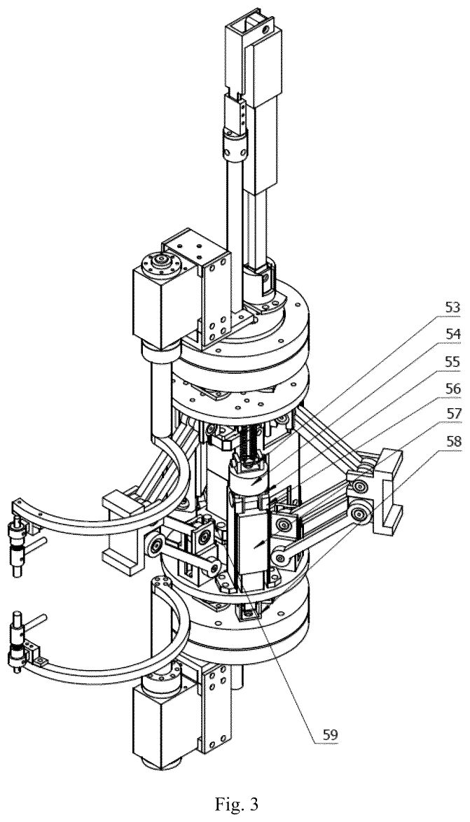

FIG. 4 is a side view of FIG. 3;

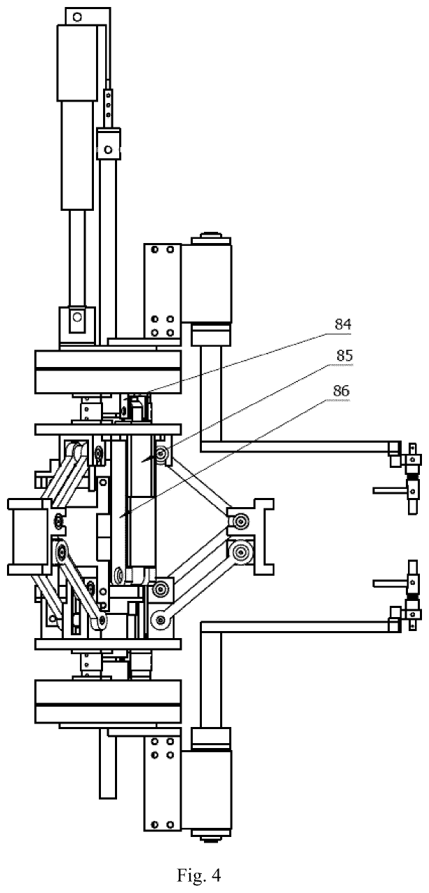

FIG. 5 is an internal structural sectional view of the present invention;

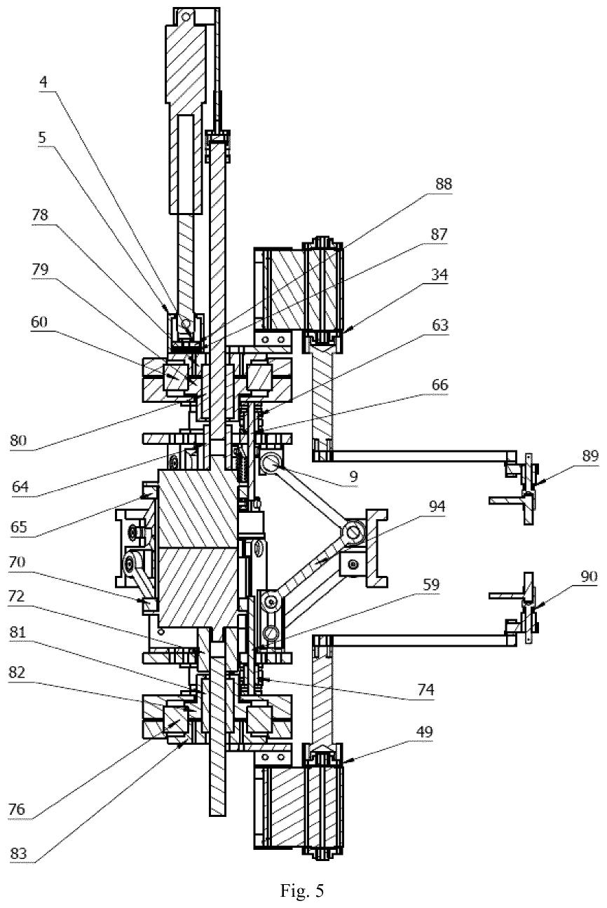

FIG. 6 is a structural schematic diagram of an overall folded free state of the present invention.

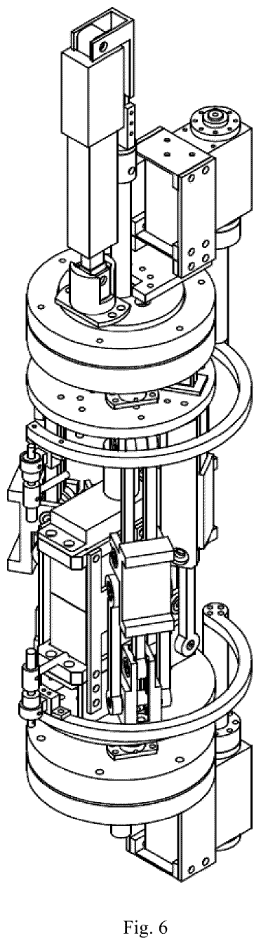

In the figures: 1—power-on push rod adjusting plate; 2—power-on push rod; 3—power-on push rod adjusting base; 4—power-on push rod connecting base; 5—power-on push rod buffer spring fixing housing; 6—first upper rotating ball bearing outer ring fixing disc; 7—second upper rotating ball bearing outer ring fixing disc; 8—upper connecting disc; 9—upper rotating shaft; 10—upper rotating shaft small bearing; 11—upper rotating shaft seat; 12—upper supporting rotating arm; 13—circumferential jaw; 14—jaw upper rotating shaft; 15—jaw upper rotating shaft small bearing; 16—jaw lower rotating shaft; 17—jaw lower rotating shaft small bearing; 18—second lower supporting rotating arm; 19—lower rotating shaft small bearing; 20—first lower rotating shaft; 21—second lower rotating shaft; 22—lower rotating shaft seat; 23—lower connecting disc; 24—second lower rotating ball bearing outer ring fixing disc; 25—first lower rotating ball bearing outer ring fixing disc; 26—lower sliding spline shaft; 27—power-on push rod installing ring; 28—upper sliding spline shaft; 29—upper probe arm rotating steering engine installing bottom edge; 30—upper probe arm rotating steering engine installing side edge; 31—upper probe arm rotating steering engine rack installing base; 32—upper probe arm rotating steering engine; 33—upper probe arm rotating steering engine wheel; 34—upper probe vertical extension arm; 35—upper probe horizontal extension arm; 36—upper probe adjusting base; 37—upper probe bearing clamping and adjusting rod; 38—upper probe movable linear bearing; 39—upper probe clamping rod; 40—upper probe; 41—lower probe horizontal extension arm; 42—lower probe; 43—lower probe adjusting base; 44—lower probe clamping rod; 45—lower probe movable linear bearing; 46—lower probe bearing clamping and adjusting rod; 47—lower probe vertical extension arm; 48—lower probe arm rotating steering engine rack installing base; 49—lower probe arm rotating steering engine wheel; 50—lower probe arm rotating steering engine; 51—lower probe arm rotating steering engine installing bottom edge; 52—lower probe arm rotating steering engine installing side edge; 53—electromagnet tension spring installing base; 54—electromagnet; 55—magnetic absorption auxiliary base; 56—middle second electric push rod connecting side plate; 57—middle second electric push rod; 58—middle second electric push rod connecting base; 59—lower linkage optical axis; 60—upper rotating ball bearing; 61—upper linkage optical axis base; 62—upper linkage linear bearing base; 63—upper linkage linear bearing; 64—upper coupling; 65—middle steering engine first installing edge; 66—upper linkage optical axis; 67—middle first and second steering engine connecting plate; 68—first middle steering engine; 69—second middle steering engine; 70—middle steering engine second installing edge; 71—middle steering engine first and second installing and connecting base; 72—lower coupling; 73—lower linkage linear bearing base; 74—lower linkage linear bearing; 75—lower linkage optical axis base; 76—lower rotating ball bearing; 77—rack tension spring installing base; 78—first upper rotating ball bearing inner ring fixing disc; 79—second upper rotating ball bearing inner ring fixing disc; 80—upper ball spline sleeve; 81—lower ball spline sleeve; 82—second lower rotating ball bearing inner ring fixing disc; 83—first lower rotating ball bearing inner ring fixing disc; 84—middle first electric push rod connecting base; 85—middle first electric push rod; 86—middle first electric push rod connecting side plate; 87—power-on push rod buffer spring; 88—power-on push rod buffer spring disc; 89—upper probe buffer spring; 90—lower probe buffer spring; 91—tension spring installing rod; 92—tension spring installing rod fixing nut; 93—tension spring; 94—first lower supporting rotating arm.

### DETAILED DESCRIPTION

The present invention comprises a main rack, a clamping module, a lifting module, a rotating module, a telescopic module and a probe buffer module; wherein:

As shown in the figures, the main rack is used for mutual connection among the modules. The main rack comprises an upper connecting disc 8, a lower connecting disc 23, an upper sliding spline shaft 28, a lower sliding spline shaft 26, an upper rotating shaft seat 11, a lower rotating shaft seat 22, an upper ball spline sleeve 80 and a lower ball spline sleeve 81. The upper rotating shaft seat 11 and the lower rotating shaft seat 22 are connected with the upper connecting disc 8 and the lower connecting disc 23 respectively as a basis for the connection of other modules and supporting of the rack. The upper ball spline sleeve 80 and the lower ball spline sleeve 81 can freely move back and forth linearly along grooves on the upper sliding spline shaft 28 and the lower sliding spline shaft 26, and meanwhile, a less torque can be transferred to the spline sleeves through the function of maintaining axial motion for the sliding spline shafts. The upper ball spline sleeve 80 and the lower ball spline sleeve 81 are connected with a first upper rotating ball bearing inner ring fixing disc 78, a second upper rotating ball bearing inner ring fixing disc 79, a second lower rotating ball bearing inner ring fixing disc 82 and a first lower rotating ball bearing inner ring fixing disc 83 in the rotating module to drive the upper and lower parts of the whole mechanism to move back and forth along the sliding spline shafts to complete switching between the end points of two motion phases in a folded free state and an installation state. In the functional performance of realizing the own deformation of the device, the lower ball spline sleeve 81 is fixed relative to the lower connecting disc 23 and the lower sliding spline shaft 26, and has no relative displacement. When an upper mechanism is driven away from a lower mechanism by the upper ball spline sleeve 80 and moves to a farthest end, the radial dimension of the device is reduced and the axial dimension is increased correspondingly under the joint action of other modules. Stable connection of each module and reliable operation of the whole device are achieved.

As shown in the figures, the clamping module is used for installation, clamping and fixation with an element to be tested. At the same time, mechanism motion and deformation occur under the action of own power output, and the corresponding deformation and clamping functions are realized. The clamping module comprises a power-on push rod adjusting plate 1, a power-on push rod 2, a power-on push rod adjusting base 3, a power-on push rod connecting base 4, a power-on push rod buffer spring fixing housing 5, an upper rotating shaft 9, an upper rotating shaft small bearing 10, an upper rotating shaft seat 11, an upper supporting rotating arm 12, a circumferential jaw 13, a jaw upper rotating shaft 14, a jaw upper rotating shaft small bearing 15, a jaw lower rotating shaft 16, a jaw lower rotating shaft small bearing 17, a second lower supporting rotating arm 18, a lower rotating shaft small bearing 19, a first lower rotating shaft 20, a second lower rotating shaft 21, a lower rotating shaft seat 22, a power-on push rod installing ring 27, an upper sliding spline shaft 28, a power-on push rod buffer spring 87, a power-on push rod buffer spring disc 88 and a first lower supporting rotating arm 94.

A motion mechanism bracket is composed of the upper rotating shaft 9, the upper rotating shaft small bearing 10, the upper rotating shaft seat 11, the upper supporting rotating arm 12, the circumferential jaw 13, the jaw upper rotating shaft 14, the jaw upper rotating shaft small bearing 15, the jaw lower rotating shaft 16, the jaw lower rotating shaft small bearing 17, the second lower supporting rotating arm 18, the lower rotating shaft small bearing 19, the first lower rotating shaft 20, the second lower rotating shaft 21, the lower rotating shaft seat 22 and the second lower supporting rotating arm 18. One of three jaws with circumferential distribution is formed, and the complete motion mechanism bracket of the clamping module is obtained after circumferential array. A power output end is composed of the power-on push rod adjusting plate 1, the power-on push rod 2, the power-on push rod adjusting base 3, the power-on push rod connecting base 4, the power-on push rod buffer spring fixing housing 5, the power-on push rod installing ring 27, the upper sliding spline shaft 28, the power-on push rod buffer spring 87 and the power-on push rod buffer spring disc 88. When the module is operated, a power source required by the deformation and clamping actions of the device is provided by the power-on push rod 2 in the power output end. The motion of the power-on push rod 2 provides displacement output, which directly acts on the power-on push rod connecting base 4, is transferred to the power-on push rod buffer spring 87 through the power-on push rod buffer spring disc 88 and then to the main rack part through the lifting module, and finally acts on the motion mechanism bracket in the clamping module. The direction of the displacement, i.e., the clamping force is changed by 90 degrees through a typical motion mechanism in the motion mechanism, and the clamping force and the displacement are changed from axial action to radial action. Wherein the power-on push rod buffer spring 87 is also used as a safety device when the device generates lifting and other actions, and can realize the maintenance of the clamping force when the displacement output is generated by other module actions. The upper rotating shaft seat 11 and the lower rotating shaft seat 22 in the motion mechanism bracket are connected to the main rack so as to limit the two seats in the same linear direction when generating relative motion. A whole group of motion mechanism brackets distributed in a circumferential array can be simplified as a planar motion mechanism. A planar quadrilateral mechanism is composed of the circumferential jaw 13, the second lower supporting rotating arm 18, the lower rotating shaft seat 22 and the second lower supporting rotating arm 18 to ensure that the jaw may not rotate due to actions when the part of the module acts, and maintain a vertical state, so as to provide a basis for the contact and the clamping of the whole device and a tested element. At the power output end, output power is transferred to the motion mechanism bracket by other modules, and the mechanism deforms and moves to finally realize installation, clamping and fixation between an automated testing device and the element to be tested.

The clamping force in the clamping module can be applied by the power-on push rod 2, and can also be provided by an electromagnet and a tension spring. The part comprises: an electromagnet tension spring installing base 53, an electromagnet 54, a magnetic attraction auxiliary base 55, a rack tension spring installing base 77, a tension spring installing rod 91, a tension spring installing rod fixing nut 92 and a tension spring 93. During operation, the electromagnet 54 and the magnetic attraction auxiliary base 55 are mutually attached; a middle second electric push rod connecting side plate 56 and a middle second electric push rod 57 are used for transferring a spring tension force generated by the tension spring 93 to the lower connecting disc 23; meanwhile, the tension spring 93 is connected with the rack tension spring installing base 77; the tension force is transferred to the upper connecting disc 8, which is represented as an acting force between the upper connecting disc 8 and the lower connecting disc 23; and the function is equivalent to an operating state when a thrust exerted by the power-on push rod 2 acts on the main rack, and finally acts on the motion mechanism bracket in the clamping module.

As shown in the figures, the lifting modules are placed axially and symmetrically at both ends in the present invention. The testing device is used for driving each module carried above a lifting platform to conduct reciprocating lifting/dropping actions. The final performance is the lifting and dropping action required by probes at both sides when switching between different measuring points. The lifting module comprises a first upper rotating ball bearing outer ring fixing disc 6, a second upper rotating ball bearing outer ring fixing disc 7, an upper connecting disc 8, a lower connecting disc 23, a second lower rotating ball bearing outer ring fixing disc 24, a first lower rotating ball bearing outer ring fixing disc 25, a lower sliding spline shaft 26, an upper sliding spline shaft 28, a magnetic absorption auxiliary base 55, a middle second electric push rod connecting side plate 56, a middle second electric push rod 57, a middle second electric push rod connecting base 58, a lower linkage optical axis 59, an upper rotating ball bearing 60, an upper linkage optical axis base 61, an upper linkage linear bearing base 62, an upper linkage linear bearing 63, an upper linkage optical axis 66, a lower linkage linear bearing base 73, a lower linkage linear bearing 74, a lower linkage optical axis base 75, a lower rotating ball bearing 76, a first upper rotating ball bearing inner ring fixing disc 78, a second upper rotating ball bearing inner ring fixing disc 79, an upper ball spline sleeve 80, a lower ball spline sleeve 81, a second lower rotating ball bearing inner ring fixing disc 82, a first lower rotating ball bearing inner ring fixing disc 83, a middle first electric push rod connecting base 84, a middle first electric push rod 85, and a middle first electric push rod connecting side plate 86.

The power output end of the lifting module is composed of the upper connecting disc 8, the lower connecting disc 23, the magnetic absorption auxiliary base 55, the middle second electric push rod connecting side plate 56, the middle second electric push rod 57, the middle second electric push rod connecting base 58, the middle first electric push rod connecting base 84, the middle first electric push rod 85 and the middle first electric push rod connecting side plate 86 to provide the power required for the lifting/dropping action.

The motion mechanism bracket is composed of a first upper rotating ball bearing outer ring fixing disc 6, a second upper rotating ball bearing outer ring fixing disc 7, a second lower rotating ball bearing outer ring fixing disc 24, a first lower rotating ball bearing outer ring fixing disc 25, a lower sliding spline shaft 26, an upper sliding spline shaft 28, a lower linkage optical axis 59, an upper rotating ball bearing 60, an upper linkage optical axis base 61, an upper linkage linear bearing base 62, an upper linkage linear bearing 63, an upper linkage optical axis 66, a lower linkage linear bearing base 73, a lower linkage linear bearing 74, a lower linkage optical axis base 75, a lower rotating ball bearing 76, a first upper rotating ball bearing inner ring fixing disc 78, a second upper rotating ball bearing inner ring fixing disc 79, an upper ball spline sleeve 80, a lower ball spline sleeve 81, a second lower rotating ball bearing inner ring fixing disc 82, and a first lower rotating ball bearing inner ring fixing disc 83.

The first upper rotating ball bearing inner ring fixing disc 78 and the first lower rotating ball bearing inner ring fixing disc 83 are the lifting platforms connected directly to other parts in the lifting module. The upper linkage optical axis base 61 and the lower linkage optical axis base 75 are used for fixing the upper linkage optical axis 66 and the lower linkage optical axis 59 respectively. The upper linkage linear bearing base 62 and the lower linkage linear bearing base 73 are used for fixing the upper linkage linear bearing 63 and the lower linkage linear bearing 74 respectively. The linear bearing and the linkage optical axis are matched to realize smooth axial motion between the linkage linear bearing base and the linkage optical axis base, and are called a group of lifting bearing mechanisms. Three groups of lifting bearing mechanisms distributed by the circumferential array ensure that the lifting module can move along the axial direction during actions, to avoid the deviation of the lifting platform in the axial section direction. When the lift/dropping action occurs, the displacement output is provided by the middle first electric push rod 85 and the middle second electric push rod 57, transferred to the rotating module by the middle first electric push rod connecting base 84 and the middle second electric push rod connecting base 58, and finally transferred to the lifting platforms in the lifting module to drive other modules on the platforms to move together. The three groups of lifting bearing mechanisms distributed by the circumferential array ensure that the overall motion direction of the lifting module does not deviate when subjected to the acting force of the electric push rod to realize the motion along the axis direction. The lifting module has the function of driving other modules by the lifting platforms to conduct the lifting/dropping actions, which is represented in the whole testing device as the lifting and dropping actions required when the probes at both sides are switched between different measuring points.

As shown in the figures, part of the rotating module is placed symmetrically at both axial ends of the present invention to realize the circumferential rotation function of the rotating platform relative to the stator part, and part of the components participate in the function when other modules such as the lifting module are operated. The rotating module has the function of realizing circumferential rotation by the whole testing device to drive other modules connected to the rotating platform to rotate together. In the operation of the whole testing device, the performance is the control function of the rotation action and the accurate rotation angle required by a testing probe when an element to be measured is switched between different measuring points. The rotating module comprises a first upper rotating ball bearing outer ring fixing disc 6, a second upper rotating ball bearing outer ring fixing disc 7, a second lower rotating ball bearing outer ring fixing disc 24, a first lower rotating ball bearing outer ring fixing disc 25, a lower sliding spline shaft 26, an upper sliding spline shaft 28, an upper rotating ball bearing 60, an upper coupling 64, a middle steering engine first installing edge 65, a middle first and second steering engine connecting plate 67, a first middle steering engine 68, a second middle steering engine 69, a middle steering engine second installing edge 70, a middle steering engine first and second installing and connecting base 71, a lower coupling 72, a lower rotating ball bearing 76, a first upper rotating ball bearing inner ring fixing disc 78, a second upper rotating ball bearing inner ring fixing disc 79, an upper ball spline sleeve 80, a lower ball spline sleeve 81, a second lower rotating ball bearing inner ring fixing disc 82, and a first lower rotating ball bearing inner ring fixing disc 83.

A power output end in the rotating module is composed of the middle steering engine first installing edge 65, the middle first and second steering engine connecting plate 67, the first middle steering engine 68, the second middle steering engine 69, the middle steering engine second installing edge 70, and the middle steering engine first and second installing and connecting base 71.

The motion mechanism bracket is composed of the first upper rotating ball bearing outer ring fixing disc 6, the second upper rotating ball bearing outer ring fixing disc 7, the second lower rotating ball bearing outer ring fixing disc 24, the first lower rotating ball bearing outer ring fixing disc 25, the lower sliding spline shaft 26, the upper sliding spline shaft 28, the upper rotating ball bearing 60, the upper coupling 64, the lower coupling 72, the lower rotating ball bearing 76, the first upper rotating ball bearing inner ring fixing disc 78, the second upper rotating ball bearing inner ring fixing disc 79, the upper ball spline sleeve 80, the lower ball spline sleeve 81, the second lower rotating ball bearing inner ring fixing disc 82, and the first lower rotating ball bearing inner ring fixing disc 83.

The first middle steering engine 68 and the second middle steering engine 69 control the rotation of the upper rotating part and the lower rotating part respectively. Accurate angle control and rotating torque are provided through the steering engines, transferred from the upper coupling 64 and the lower coupling 72 to the lower sliding spline shaft 26 and the upper sliding spline shaft 28, and finally transferred to the rotor part connected therewith through the upper ball spline sleeve 80 and the lower ball spline sleeve 81 by means of the coordination and torque transfer between the sliding spline shaft and the ball spline sleeve to realize the function of rotation and angle control.

The first upper rotating ball bearing outer ring fixing disc 6, the second upper rotating ball bearing outer ring fixing disc 7, the second lower rotating ball bearing outer ring fixing disc 24 and the first lower rotating ball bearing outer ring fixing disc 25 in the motion mechanism bracket are connected with the fixed part of the whole device, which is the stator part of the rotating module. The rotor part in the rotating module is composed of the lower sliding spline shaft 26, the upper sliding spline shaft 28, the upper rotating ball bearing 60, the upper coupling 64, the lower coupling 72, the lower rotating ball bearing 76, the first upper rotating ball bearing inner ring fixing disc 78, the second upper rotating ball bearing inner ring fixing disc 79, the upper ball spline sleeve 80, the lower ball spline sleeve 81, the second lower rotating ball bearing inner ring fixing disc 82 and the first lower rotating ball bearing inner ring fixing disc 83. The stator part and the rotor part connected with the upper rotating ball bearing 60 and the lower rotating ball bearing 76 in the rotating module ensure that the rotor part can rotate stably relative to the stator part, i.e., other parts of the whole device when the rotating module is operated and rotated, and ensure the coaxiality and the stability of rotation. The final performance in the rotor part is: the first upper rotating ball bearing inner ring fixing disc 78 and the first lower rotating ball bearing inner ring fixing disc 83 are used as rotating platforms directly connected with other modules, and can rotate smoothly relative to the whole device, so as to finally drive a probe extension arm and a testing probe connected to the rotating platforms to realize stable arrival and switching between different measuring points of the element to be measured.

As shown in the figures, the telescopic modules are placed symmetrically at both axial ends of the present invention, used to achieve the rotation of rod components, and manifested as radial dimensional expansion and contraction. In the whole testing device, the performance is to drive a probe part at the end of a rod of the telescopic module to move in the radial direction. The telescopic module comprises an upper probe arm rotating steering engine installing bottom edge 29, an upper probe arm rotating steering engine installing side edge 30, an upper probe arm rotating steering engine rack installing base 31, an upper probe arm rotating steering engine 32, an upper probe arm rotating steering engine wheel 33, an upper probe vertical extension arm 34, an upper probe horizontal extension arm 35, an upper probe adjusting base 36, an upper probe bearing clamping and adjusting rod 37, a lower probe horizontal extension arm 41, a lower probe adjusting base 43, a lower probe bearing clamping and adjusting rod 46, a lower probe vertical extension arm 47, a lower probe arm rotating steering engine rack installing base 48, a lower probe arm rotating steering engine wheel 49, a lower probe arm rotating steering engine 50, a lower probe arm rotating steering engine installing bottom edge 51 and a lower probe arm rotating steering engine installing side edge 52.

The power output end in the telescopic module is composed of the upper probe arm rotating steering engine wheel 33, the upper probe vertical extension arm 34, the upper probe horizontal extension arm 35, the upper probe adjusting base 36, the upper probe bearing clamping and adjusting rod 37, the lower probe horizontal extension arm 41, the lower probe adjusting base 43, the lower probe bearing clamping and adjusting rod 46, the lower probe vertical extension arm 47 and the lower probe arm rotating steering engine wheel 49.

The motion mechanism bracket is composed of the upper probe arm rotating steering engine installing bottom edge 29, the upper probe arm rotating steering engine installing side edge 30, the upper probe arm rotating steering engine rack installing base 31, the upper probe arm rotating steering engine 32, the lower probe arm rotating steering engine rack installing base 48, the lower probe arm rotating steering engine 50, the lower probe arm rotating steering engine installing bottom edge 51 and the lower probe arm rotating steering engine installing side edge 52.

When the rotating module is operated, the upper probe arm rotating steering engine 32 and the lower probe arm rotating steering engine 50 control the rotation function of the axial telescopic module structural bracket part of the upper and lower parts respectively, and the torque and angle control functions required by rotation are provided by the steering engine. The steering engine and the rotating platform in the rotating module are connected through the upper probe arm rotating steering engine installing bottom edge 29, the upper probe arm rotating steering engine installing side edge 30, the upper probe arm rotating steering engine rack installing base 31, the lower probe arm rotating steering engine rack installing base 48, the lower probe arm rotating steering engine installing bottom edge 51 and the lower probe arm rotating steering engine installing side edge 52. The first upper rotating ball bearing inner ring fixing disc 78 and the first lower rotating ball bearing inner ring fixing disc 83 are connected and fixed. The steering engine output rotating torque is transferred to the upper probe vertical extension arm 34 and the lower probe vertical extension arm 47 in the axial direction, the upper probe horizontal extension arm 35 and the lower probe horizontal extension arm 41 through the upper probe arm rotating steering engine wheel 33 and the lower probe arm rotating steering engine wheel 49, to finally realize the rotation function of a semicircular horizontal extension arm. When the horizontal extension arm rotates to a position with the smallest radial dimension in a semicircle, the semicircular horizontal extension arm is located in an outermost ring of the whole testing device. In the operating state, the semicircular horizontal extension arm rotates and extends, and the radial chord length of the semicircle is an actual extension length to realize the elongation of the radial dimension. The upper probe adjusting base 36, the upper probe bearing clamping and adjusting rod 37, the lower probe adjusting base 43 and the lower probe bearing clamping and adjusting rod 46 are matched with each other to realize the fine adjustment of the radial dimension elongation, which is convenient for finding the position of the indexing circle of the point to be measured on the measured element when the device is operated. Finally, the probe part installed at the end of the telescopic module is driven in the whole testing device to switch the free state and the operating state to drive the probe part to reach the position of the point to be measured, so as to realize the telescopic function of the radial dimension of the whole device.

As shown in the figures, the probe buffer module is arranged at the end part of the probe arm bracket part in the telescopic module, and carries a testing probe to realize the accurate positioning function of the testing probe, so as to ensure that a stable pressing force between the probe and the measured element is maintained during the operation of the automated testing device, thereby finally realizing the stability of a measuring structure and realizing the reliability and the stability of the measuring data. The probe buffer module comprises an upper probe bearing clamping and adjusting rod 37, an upper probe movable linear bearing 38, an upper probe clamping rod 39, an upper probe 40, a lower probe 42, a lower probe clamping rod 44, a lower probe movable linear bearing 45, a lower probe bearing clamping and adjusting rod 46, an upper probe buffer spring 89 and a lower probe buffer spring 90.

In the probe buffer module, the upper probe 40 and the lower probe 42 are measuring probes, and are fixed by a probe holding rod. The end of the holding rod is an optical axis, which can move in the upper probe movable linear bearing 38 and the lower probe movable linear bearing 45 along the bearing axis, thereby limiting the movable range of the probe to be perpendicular to the cross section direction of the whole device, that is, perpendicular to the direction of a measured surface of the measured element. The axial displacement applied by the lifting module is finally transferred to the probe buffer module by the rotating module and the telescopic module. The lifting displacement applied is converted into the spring compression by the upper probe buffer spring 89 and the lower probe buffer spring 90, and converted into a pressing force for keeping the stable attachment of the probe and the measured surface by the buffer spring. The final performance is to ensure that the stable pressing force between the probe and the measured element is maintained during the operation of the automated testing device to ensure the stability and the reliability of the obtained test data.

1. An ultrasonic inspection robot for a threaded connection structure of a rotor internal cavity, comprising a main rack, a clamping module, a lifting module, a rotating module, a telescopic module and a probe buffer module; wherein:
the main rack is used for mutual connection among the modules; the main rack comprises an upper connecting disc, a lower connecting disc, an upper sliding spline shaft, a lower sliding spline shaft, an upper rotating shaft seat, a lower rotating shaft seat, an upper ball spline sleeve and a lower ball spline sleeve;
the upper rotating shaft seat and the lower rotating shaft seat are connected with the upper connecting disc and the lower connecting disc respectively as a basis for the connection of other modules and supporting of the rack; the upper ball spline sleeve and the lower ball spline sleeve freely move back and forth linearly along grooves on the upper sliding spline shaft and the lower sliding spline shaft, and meanwhile, a less torque is transferred to the spline sleeves through the function of maintaining axial motion for the sliding spline shafts; the upper ball spline sleeve and the lower ball spline sleeve are connected with a first upper rotating ball bearing inner ring fixing disc, a second upper rotating ball bearing inner ring fixing disc, a second lower rotating ball bearing inner ring fixing disc and a first lower rotating ball bearing inner ring fixing disc in the rotating module to drive an upper and a lower parts of a whole mechanism to move back and forth along the sliding spline shafts to complete switching between the end points of two motion phases in a folded free state and an installation state; in the functional performance of realizing the own deformation of the device, the lower ball spline sleeve is fixed relative to the lower connecting disc and the lower sliding spline shaft, and has no relative displacement; when an upper mechanism is driven away from a lower mechanism by the upper ball spline sleeve and moves to a farthest end, the radial dimension of the device is reduced and the axial dimension is increased correspondingly under the joint action of other modules; stable connection of each module and reliable operation of the whole device are achieved;
the clamping module is used for installation, clamping and fixation with an element to be tested; at the same time, mechanism motion and deformation occur under the action of own power output, and the corresponding deformation and clamping functions are realized; the clamping module comprises a power-on push rod adjusting plate, a power-on push rod, a power-on push rod adjusting base, a power-on push rod connecting base, a power-on push rod buffer spring fixing housing, an upper rotating shaft, an upper rotating shaft small bearing, an upper rotating shaft seat, an upper supporting rotating arm, a circumferential jaw, a jaw upper rotating shaft, a jaw upper rotating shaft small bearing, a jaw lower rotating shaft, a jaw lower rotating shaft small bearing, a second lower supporting rotating arm, a lower rotating shaft small bearing, a first lower rotating shaft, a second lower rotating shaft, a lower rotating shaft seat, a power-on push rod installing ring, an upper sliding spline shaft, a power-on push rod buffer spring, a power-on push rod buffer spring disc and a first lower supporting rotating arm;
a motion mechanism bracket of the clamping module is composed of the upper rotating shaft, the upper rotating shaft small bearing, the upper rotating shaft seat, the upper supporting rotating arm, the circumferential jaw, the jaw upper rotating shaft, the jaw upper rotating shaft small bearing, the jaw lower rotating shaft, the jaw lower rotating shaft small bearing, the second lower supporting rotating arm, the lower rotating shaft small bearing, the first lower rotating shaft, the second lower rotating shaft, the lower rotating shaft seat and the second lower supporting rotating arm; one of three jaws with circumferential distribution is formed, and the complete motion mechanism bracket of the clamping module is obtained after circumferential array; a power output end of the clamping module is composed of the power-on push rod adjusting plate, the power-on push rod, the power-on push rod adjusting base, the power-on push rod connecting base, the power-on push rod buffer spring fixing housing, the power-on push rod installing ring, the upper sliding spline shaft, the power-on push rod buffer spring and the power-on push rod buffer spring disc; when the module is operated, a power source required by the deformation and clamping actions of the device is provided by the power-on push rod in the power output end; the motion of the power-on push rod provides displacement output, which directly acts on the power-on push rod connecting base, is transferred to the power-on push rod buffer spring through the power-on push rod buffer spring disc and then to the main rack part through the lifting module, and finally acts on the motion mechanism bracket in the clamping module; the direction of the displacement, i.e., the clamping force is changed by 90 degrees through a typical motion mechanism in the motion mechanism, and the clamping force and the displacement are changed from axial action to radial action; wherein the power-on push rod buffer spring is also used as a safety device when the device generates lifting and other actions, and realizes the maintenance of the clamping force when the displacement output is generated by other module actions; the upper rotating shaft seat and the lower rotating shaft seat in the motion mechanism bracket are connected to the main rack to limit the two seats in the same linear direction when generating relative motion; a whole group of motion mechanism brackets distributed in a circumferential array is simplified as a planar motion mechanism; a planar quadrilateral mechanism is composed of the circumferential jaw, the second lower supporting rotating arm, the lower rotating shaft seat and the second lower supporting rotating arm to ensure that the jaw may not rotate due to actions when the part of the module acts, and maintain a vertical state, to provide a basis for the contact and the clamping of the whole device and a tested element; at the power output end, output power is transferred to the motion mechanism bracket by other modules, and the mechanism deforms and moves to finally realize installation, clamping and fixation between an automated testing device and the element to be tested;
both ends of the lifting module are placed axially and symmetrically; the testing device is used for driving each module carried above a lifting platform to conduct reciprocating lifting/dropping actions; the final performance is the lifting and dropping action required by probes at both sides when switching between different measuring points; the lifting module comprises a first upper rotating ball bearing outer ring fixing disc, a second upper rotating ball bearing outer ring fixing disc, an upper connecting disc, a lower connecting disc, a second lower rotating ball bearing outer ring fixing disc, a first lower rotating ball bearing outer ring fixing disc, a lower sliding spline shaft, an upper sliding spline shaft, a magnetic absorption auxiliary base, a middle second electric push rod connecting side plate, a middle second electric push rod, a middle second electric push rod connecting base, a lower linkage optical axis, an upper rotating ball bearing, an upper linkage optical axis base, an upper linkage linear bearing base, an upper linkage linear bearing, an upper linkage optical axis, a lower linkage linear bearing base, a lower linkage linear bearing, a lower linkage optical axis base, a lower rotating ball bearing, a first upper rotating ball bearing inner ring fixing disc, a second upper rotating ball bearing inner ring fixing disc, an upper ball spline sleeve, a lower ball spline sleeve, a second lower rotating ball bearing inner ring fixing disc, a first lower rotating ball bearing inner ring fixing disc, a middle first electric push rod connecting base, a middle first electric push rod, and a middle first electric push rod connecting side plate;
the power output end of the lifting module is composed of the upper connecting disc, the lower connecting disc, the magnetic absorption auxiliary base, the middle second electric push rod connecting side plate, the middle second electric push rod, the middle second electric push rod connecting base, the middle first electric push rod connecting base, the middle first electric push rod and the middle first electric push rod connecting side plate to provide the power required for the lifting/dropping action;
the motion mechanism bracket of the lifting module is composed of a first upper rotating ball bearing outer ring fixing disc, a second upper rotating ball bearing outer ring fixing disc, a second lower rotating ball bearing outer ring fixing disc, a first lower rotating ball bearing outer ring fixing disc, a lower sliding spline shaft, an upper sliding spline shaft, a lower linkage optical axis, an upper rotating ball bearing, an upper linkage optical axis base, an upper linkage linear bearing base, an upper linkage linear bearing, an upper linkage optical axis, a lower linkage linear bearing base, a lower linkage linear bearing, a lower linkage optical axis base, a lower rotating ball bearing, a first upper rotating ball bearing inner ring fixing disc, a second upper rotating ball bearing inner ring fixing disc, an upper ball spline sleeve, a lower ball spline sleeve, a second lower rotating ball bearing inner ring fixing disc, and a first lower rotating ball bearing inner ring fixing disc;
the first upper rotating ball bearing inner ring fixing disc and the first lower rotating ball bearing inner ring fixing disc are the lifting platforms connected directly to other parts in the lifting module; the upper linkage optical axis base and the lower linkage optical axis base are used for fixing the upper linkage optical axis and the lower linkage optical axis respectively; the upper linkage linear bearing base and the lower linkage linear bearing base are used for fixing the upper linkage linear bearing and the lower linkage linear bearing respectively; the linear bearing and the linkage optical axis are matched to realize smooth axial motion between the linkage linear bearing base and the linkage optical axis base, and are called a group of lifting bearing mechanisms; three groups of lifting bearing mechanisms distributed by the circumferential array ensure that the lifting module can move along an axial direction during actions, to avoid the deviation of the lifting platform in an axial section direction; when the lift/dropping action occurs, displacement output is provided by the middle first electric push rod and the middle second electric push rod, transferred to the rotating module by the middle first electric push rod connecting base and the middle second electric push rod connecting base, and finally transferred to the lifting platforms in the lifting module to drive other modules on the platforms to move together; the three groups of lifting bearing mechanisms distributed by the circumferential array ensure that the overall motion direction of the lifting module does not deviate when subjected to the acting force of the electric push rod to realize the motion along the axis direction; the lifting module has the function of driving other modules by the lifting platforms to conduct the lifting/dropping actions, which is represented in the whole testing device as the lifting and dropping actions required when the probes at both sides are switched between different measuring points;
part of the rotating module is placed symmetrically at both axial ends to realize the circumferential rotation function of the rotating platform relative to a stator part, and part of the components participate in the function when the lifting module and other modules are operated; the rotating module has the function of realizing circumferential rotation by the whole testing device to drive other modules connected to the rotating platform to rotate together; in the operation of the whole testing device, the performance is the control function of the rotation action and the accurate rotation angle required by a testing probe when an element to be measured is switched between different measuring points; the rotating module comprises a first upper rotating ball bearing outer ring fixing disc, a second upper rotating ball bearing outer ring fixing disc, a second lower rotating ball bearing outer ring fixing disc, a first lower rotating ball bearing outer ring fixing disc, a lower sliding spline shaft, an upper sliding spline shaft, an upper rotating ball bearing, an upper coupling, a middle steering engine first installing edge, a middle first and second steering engine connecting plate, a first middle steering engine, a second middle steering engine, a middle steering engine second installing edge, a middle steering engine first and second installing and connecting base, a lower coupling, a lower rotating ball bearing, a first upper rotating ball bearing inner ring fixing disc, a second upper rotating ball bearing inner ring fixing disc, an upper ball spline sleeve, a lower ball spline sleeve, a second lower rotating ball bearing inner ring fixing disc, and a first lower rotating ball bearing inner ring fixing disc;
a power output end of the rotating module is composed of the middle steering engine first installing edge, the middle first and second steering engine connecting plate, the first middle steering engine, the second middle steering engine, the middle steering engine second installing edge, and the middle steering engine first and second installing and connecting base;
the motion mechanism bracket of the rotating module is composed of the first upper rotating ball bearing outer ring fixing disc, the second upper rotating ball bearing outer ring fixing disc, the second lower rotating ball bearing outer ring fixing disc, the first lower rotating ball bearing outer ring fixing disc, the lower sliding spline shaft, the upper sliding spline shaft, the upper rotating ball bearing, the upper coupling, the lower coupling, the lower rotating ball bearing, the first upper rotating ball bearing inner ring fixing disc, the second upper rotating ball bearing inner ring fixing disc, the upper ball spline sleeve, the lower ball spline sleeve, the second lower rotating ball bearing inner ring fixing disc, and the first lower rotating ball bearing inner ring fixing disc;
the first middle steering engine and the second middle steering engine control the rotation of an upper rotating part and a lower rotating part respectively; accurate angle control and rotating torque are provided through the steering engines, transferred from the upper coupling and the lower coupling to the lower sliding spline shaft and the upper sliding spline shaft, and finally transferred to a rotor part connected therewith through the upper ball spline sleeve and the lower ball spline sleeve by means of the coordination and torque transfer between the sliding spline shaft and the ball spline sleeve to realize the function of rotation and angle control;
the first upper rotating ball bearing outer ring fixing disc, the second upper rotating ball bearing outer ring fixing disc, the second lower rotating ball bearing outer ring fixing disc and the first lower rotating ball bearing outer ring fixing disc in the motion mechanism bracket are connected with a fixed part of the whole device, which is the stator part of the rotating module; the rotor part in the rotating module is composed of the lower sliding spline shaft, the upper sliding spline shaft, the upper rotating ball bearing, the upper coupling, the lower coupling, the lower rotating ball bearing, the first upper rotating ball bearing inner ring fixing disc, the second upper rotating ball bearing inner ring fixing disc, the upper ball spline sleeve, the lower ball spline sleeve, the second lower rotating ball bearing inner ring fixing disc and the first lower rotating ball bearing inner ring fixing disc; the stator part and the rotor part connected with the upper rotating ball bearing and the lower rotating ball bearing in the rotating module ensure that the rotor part can rotate stably relative to the stator part, i.e., other parts of the whole device when the rotating module is operated and rotated, and ensure the coaxiality and the stability of rotation; the final performance in the rotor part is: the first upper rotating ball bearing inner ring fixing disc and the first lower rotating ball bearing inner ring fixing disc are used as rotating platforms directly connected with other modules, and can rotate smoothly relative to the whole device, to finally drive a probe extension arm and a testing probe connected to the rotating platforms to realize stable arrival and switching between different measuring points of the element to be measured;
the telescopic modules are placed symmetrically at both axial ends, used to achieve the rotation of rod components, and manifested as radial dimensional expansion and contraction; in the whole testing device, the performance is to drive a probe part at the end of a rod of the telescopic module to move in a radial direction; the telescopic module comprises an upper probe arm rotating steering engine installing bottom edge, an upper probe arm rotating steering engine installing side edge, an upper probe arm rotating steering engine rack installing base, an upper probe arm rotating steering engine, an upper probe arm rotating steering engine wheel, an upper probe vertical extension arm, an upper probe horizontal extension arm, an upper probe adjusting base, an upper probe bearing clamping and adjusting rod, a lower probe horizontal extension arm, a lower probe adjusting base, a lower probe bearing clamping and adjusting rod, a lower probe vertical extension arm, a lower probe arm rotating steering engine rack installing base, a lower probe arm rotating steering engine wheel, a lower probe arm rotating steering engine, a lower probe arm rotating steering engine installing bottom edge and a lower probe arm rotating steering engine installing side edge;
the power output end of the telescopic module is composed of the upper probe arm rotating steering engine wheel, the upper probe vertical extension arm, the upper probe horizontal extension arm, the upper probe adjusting base, the upper probe bearing clamping and adjusting rod, the lower probe horizontal extension arm, the lower probe adjusting base, the lower probe bearing clamping and adjusting rod, the lower probe vertical extension arm and the lower probe arm rotating steering engine wheel;
the motion mechanism bracket of the telescopic module is composed of the upper probe arm rotating steering engine installing bottom edge, the upper probe arm rotating steering engine installing side edge, the upper probe arm rotating steering engine rack installing base, the upper probe arm rotating steering engine, the lower probe arm rotating steering engine rack installing base, the lower probe arm rotating steering engine, the lower probe arm rotating steering engine installing bottom edge and the lower probe arm rotating steering engine installing side edge;
when the rotating module is operated, the upper probe arm rotating steering engine and the lower probe arm rotating steering engine control the rotation function of the motion mechanism bracket of the telescopic module of the axial upper and lower parts respectively, and the torque and angle control functions required by rotation are provided by the steering engine; the steering engine and the rotating platform in the rotating module are connected through the upper probe arm rotating steering engine installing bottom edge, the upper probe arm rotating steering engine installing side edge, the upper probe arm rotating steering engine rack installing base, the lower probe arm rotating steering engine rack installing base, the lower probe arm rotating steering engine installing bottom edge and the lower probe arm rotating steering engine installing side edge; the first upper rotating ball bearing inner ring fixing disc and the first lower rotating ball bearing inner ring fixing disc are connected and fixed; the steering engine output rotating torque is transferred to the upper probe vertical extension arm and the lower probe vertical extension arm in the axial direction through the upper probe arm rotating steering engine wheel and the lower probe arm rotating steering engine wheel, to finally realize the rotation function of a semicircular horizontal extension arm; when the horizontal extension arm rotates to a position with the smallest radial dimension in a semicircle, the semicircular horizontal extension arm is located in an outermost ring of the whole testing device; in an operating state, the semicircular horizontal extension arm rotates and extends, and the radial chord length of the semicircle is an actual extension length to realize the elongation of the radial dimension; the upper probe adjusting base, the upper probe bearing clamping and adjusting rod, the lower probe adjusting base and the lower probe bearing clamping and adjusting rod are matched with each other to realize the fine adjustment of the radial dimension elongation, which is convenient for finding the position of an indexing circle of a point to be measured on a measured element; finally, the probe part installed at the end of the telescopic module is driven in the whole testing device to switch a free state and the operating state to drive the probe part to reach the position of the point to be measured, to realize the telescopic function of the radial dimension of the whole device;
the probe buffer module is arranged at the end part of the probe arm bracket part in the telescopic module, and carries a testing probe to realize the accurate positioning function of the testing probe, so as to ensure that a stable pressing force between the probe and the measured element is maintained during the operation of the automated testing device, thereby finally realizing the stability of a measuring structure and realizing the reliability and the stability of the measuring data; the probe buffer module comprises an upper probe bearing clamping and adjusting rod, an upper probe movable linear bearing, an upper probe clamping rod, an upper probe, a lower probe, a lower probe clamping rod, a lower probe movable linear bearing, a lower probe bearing clamping and adjusting rod, an upper probe buffer spring and a lower probe buffer spring;
in the probe buffer module, the upper probe and the lower probe are measuring probes, and are fixed by a probe holding rod; the end of the holding rod is an optical axis, which can move in the upper probe movable linear bearing and the lower probe movable linear bearing along the bearing axis, thereby limiting the movable range of the probe to be perpendicular to the cross section direction of the whole device, that is, perpendicular to the direction of a measured surface of the measured element; the axial displacement applied by the lifting module is finally transferred to the probe buffer module by the rotating module and the telescopic module; the lifting displacement applied is converted into the spring compression by the upper probe buffer spring and the lower probe buffer spring, and converted into a pressing force for keeping the stable attachment of the probe and the measured surface by the buffer spring; and the final performance is to ensure that the stable pressing force between the probe and the measured element is maintained during the operation of the automated testing device to ensure the stability and the reliability of the obtained test data.

2. The ultrasonic inspection robot for the threaded connection structure of the rotor internal cavity according to claim 1, further comprising an automated control operating system which comprises a power supply, a single chip microcomputer core board, a control board, a switch, an indicator light and a bracket; wherein the automated control operating system is installed by the bracket, to play the function of fixation and protection; and the automated control operating system and the ultrasonic inspection robot are controlled by wired connection.

3. The ultrasonic inspection robot for the threaded connection structure of the rotor internal cavity according to claim 1, wherein the clamping force in the clamping module is provided by an electromagnet and a tension spring; the part comprises an electromagnet tension spring installing base, an electromagnet, a magnetic attraction auxiliary base, a rack tension spring installing base, a tension spring installing rod, a tension spring installing rod fixing nut and a tension spring; during operation, the electromagnet and the magnetic attraction auxiliary base are mutually attached; a middle second electric push rod connecting side plate and a middle second electric push rod are used for transferring a spring tension force generated by the tension spring to the lower connecting disc; meanwhile, the tension spring is connected with the rack tension spring installing base; the tension force is transferred to the upper connecting disc, which is represented as an acting force between the upper connecting disc and the lower connecting disc; and the function is equivalent to an operating state when a thrust exerted by the power-on push rod acts on the main rack, and finally acts on the motion mechanism bracket in the clamping module.
